(19) United States
(12) Patent Application Publication
(10) Pub. No.: US 2016/0307216 A1
(43) Pub. Date: Oct. 20, 2016

(54) ELECTRONIC INFORMATION COLLECTION METHOD AND APPARATUS

(71) Applicant: Tencent Technology (Shenzhen) Company Limited, Shenzhen (CN)

(72) Inventors: Wa YE, Shenzhen (CN); Xiaoxin WANG, Shenzhen (CN); Zhouwei ZHU, Shenzhen (CN)

(21) Appl. No.: 15/192,610

(22) Filed: Jun. 24, 2016

Related U.S. Application Data
(63) Continuation of application No. PCT/CN2015/082431, filed on Jun. 26, 2015.

(30) Foreign Application Priority Data
Jun. 27, 2014 (CN) 201410301122.4

(51) Int. Cl. G06Q 30/02; G06Q 20/32

(52) U.S. Cl. CPC G06Q 30/0201; G06Q 20/322; G06Q 50/01

(57) ABSTRACT

An electronic information collection method and apparatus are applied to a terminal. According to the method, a social networking application installed in the terminal is described, and at least one electronic information identifier of electronic information is collected from each system platform. The social networking application provides a unified electronic information interface compatible with different third-party system platforms. According to the method, electronic information corresponding to each electronic information identifier is acquired by using the electronic information interface; the acquired electronic information is saved to generate a unified collection; and the electronic information is then forwarded to another party according to a received instruction.

### RELATED APPLICATIONS

This application is a continuation application of PCT Patent Application No. PCT/CN2015/082431, entitled “ELECTRONIC INFORMATION COLLECTION METHOD AND APPARATUS” filed on Jun. 26, 2015, which claims priority to Chinese Patent Application No. 201410301122.4, filed on Jun. 27, 2014, both of which are hereby incorporated by reference in their entirety.

### FIELD OF THE TECHNOLOGY

The present disclosure relates to the field of information processing technologies, and in particular, to an electronic information collection method and apparatus.

### BACKGROUND OF THE DISCLOSURE

With the arrival of the electronic age, traditional tangible information is gradually evolved into electronic information. For example, cards, coupons, and tickets as traditional marketing tools of merchants are gradually extended into electronic cards, coupons, and tickets, and the electronic cards, coupons, and tickets have an increasingly wider application range and have increasingly more types. Therefore, to facilitate management on various types of electronic information by a user, it is necessary to provide a solution for collecting various types of electronic information.

Currently, multiple third-party system platforms all provide a corresponding electronic information collection method, and in order to collect electronic information, each system platform provides an electronic information interface compatible with each system platform, so as to collect, by using electronic information interfaces of different third-party system platforms, electronic information in the third-party system platforms. Therefore, in order to make the collected electronic information relatively comprehensive to perform unified management on the electronic information in each system platform, it needs to set the electronic information interface compatible with each system platform, and the electronic information in each system platform is collected by using each electronic information interface.

Because when the electronic information in each system platform is collected, it needs to set the electronic information interface compatible with each system platform, not only are the complexity and the cost of collecting the electronic information increased, but also the efficiency of collecting the electronic information is lowered.

### SUMMARY

In view of this, embodiments of the present invention provide an electronic information collection method and apparatus. The technical solutions are as follows:

According to one aspect, an electronic information collection method is provided, the method being applied to a terminal, the terminal including a memory, one or more processors, and a program instruction stored in the memory and executed by the one or more processors, and the method including: providing a social networking application installed in the terminal, the social networking application providing a unified electronic information interface compatible with different third-party system platforms; collecting at least one electronic information identifier from each of the third-party system platforms; acquiring, by using the unified electronic information interface compatible with different third-party system platforms in the social networking application, electronic information corresponding to each of the at least one electronic information identifier, from the third-party system platforms; generating an unified collection by saving the acquired electronic information; and processing the electronic information according to a received instruction.

According to another aspect, an electronic information collection apparatus is provided, the apparatus being applied to a terminal. The terminal is an electronic device, which may include a memory, one or more processors, and one or more program modules stored in the memory and executed by the one or more processors. The program modules includes: a first acquiring module, configured to provide a social networking application installed in the terminal, the social networking application providing a unified electronic information interface compatible with different third-party system platforms; the first acquiring module, further configured to collect at least one electronic information identifier from each of the third-party system platforms; a second acquiring module, configured to acquire, by using the unified electronic information interface compatible with different third-party system platforms in the social networking application, electronic information corresponding to each of the at least one electronic information identifier, from the third-party system platforms; and a collection module, configured to generate an unified collection by saving the acquired electronic information, and process the electronic information according to a received instruction.

Electronic information in each system platform is collected by using a unified electronic information interface compatible with each system platform and provided by a social networking application, so that not only are the complexity and the cost of collecting the electronic information reduced, but also the efficiency of collecting the electronic information is improved.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an electronic information collection method according to an embodiment of the present invention;

FIG. 2 is a flowchart of an electronic information collection method according to another embodiment of the present invention;

FIG. 3 is a schematic diagram of an electronic information presentation interface according to another embodiment of the present invention;

FIG. 4 is a schematic diagram of another electronic information presentation interface according to another embodiment of the present invention;

FIG. 5 is a schematic structural diagram of an electronic information collection apparatus according to another embodiment of the present invention;

FIG. 6 is a schematic structural diagram of an electronic information collection apparatus according to another embodiment of the present invention;

FIG. 7 is a schematic structural diagram of an electronic information collection apparatus according to another embodiment of the present invention;

FIG. 8 is a schematic structural diagram of an electronic information collection apparatus according to another embodiment of the present invention;

FIG. 9 is a schematic structural diagram of an electronic information collection apparatus according to another embodiment of the present invention;

FIG. 10 is a schematic structural diagram of an electronic information collection apparatus according to another embodiment of the present invention; and

FIG. 11 is schematic structural diagram of a terminal according to another embodiment of the present invention.

### DESCRIPTION OF EMBODIMENTS

To make the objective, technical solutions, and advantages of the present disclosure clearer, the following further describes the embodiments of the present invention in detail with reference to the accompanying drawings.

In order to collect electronic information, each system platform provides an electronic information interface compatible with each system platform; therefore, in order to collect electronic information in each system platform, it needs to set the electronic information interface compatible with each system platform, so as to collect the electronic information in each system platform by using each electronic information interface, which not only increases the complexity and the cost of collecting the electronic information, but also lowers the efficiency of collecting the electronic information. However, because there are many applications compatible with different third-party system platforms currently, in order to reduce the complexity and the cost of collecting the electronic information, and improve the efficiency of collecting the electronic information, embodiments of the present invention provide an electronic information collection method. The method is based on a social networking application that can be compatible with different third-party system platforms to provide a unified electronic information interface, so as to collect electronic information in different third-party system platforms by using the unified electronic information interface. In specific implementation, the electronic information collection method is applicable to a terminal, an electronic information collection apparatus is run on the terminal, and the electronic information collection apparatus is an electronic information collection apparatus described in the following embodiments. The electronic information collection apparatus may acquire the electronic information in each system platform by using the unified electronic information interface.

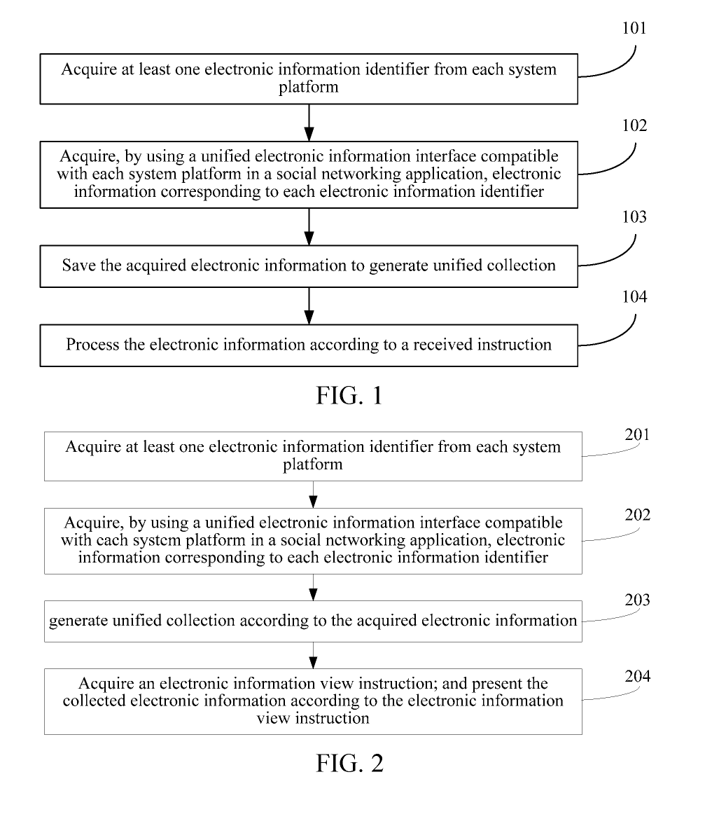

With reference to the foregoing implementation environment, this embodiment provides an electronic information collection method. The method is applied to a terminal having a social networking application compatible with each system platform installed, where the social networking application provides a unified electronic information interface compatible with each system platform. Referring to FIG. 1, a procedure of the method provided by this embodiment is specifically as follows:

101: Acquire at least one electronic information identifier of electronic information in each system platform.

102: Acquire, by using the unified electronic information interface compatible with each system platform in the social networking application, electronic information corresponding to each electronic information identifier.

103: Save the acquired electronic information to perform unified collection.

104: Process the electronic information according to a received instruction.

Specifically, step 104 may include: determining selected electronic information in the collected electronic information; receiving an electronic information payment instruction; acquiring, according to the electronic information payment instruction, payment information corresponding to the selected electronic information; and performing a payment operation according to the payment information.

Step 104 may further include: acquiring an electronic information view instruction; and presenting the collected electronic information according to the electronic information view instruction.

In another embodiment, the instruction in step 104 may also be a forwarding instruction. When the instruction is a forwarding instruction, step 104 includes: determining selected electronic information in the collected electronic information; receiving an electronic information forwarding instruction; determining, according to a social relationship in the social networking application, information about a target user that receives the selected electronic information; and sending, according to the information about the target user, the selected electronic information to a terminal corresponding to the target user.

When the selected electronic information fails to be sent, one piece of information is displayed on an interface provided by the terminal, to prompt that the selected electronic information fails to be sent.

When the received instruction is a deletion instruction, the processing the electronic information according to a received instruction includes: deleting the selected electronic information from the collected electronic information.

According to the method provided by this embodiment, electronic information in each system platform is collected by using a unified electronic information interface compatible with each system platform in a social networking application, so that not only are the complexity and the cost of collecting the electronic information reduced, but also the efficiency of collecting the electronic information is improved. In addition, the collected electronic information is forwarded to another terminal of a target user based on a social relationship, so that not only is a manner in which the collected electronic information is management enriched, but also social experience of a user can be improved.

In order to more clearly describe the electronic information collection method provided by the foregoing embodiment, with reference to the content and the implementation environment in the foregoing embodiment, the following embodiment is used as an example to describe in detail the electronic information collection method, and for details, refer to the following embodiment:

Another embodiment of the present invention provides an electronic information collection method. The method is applied to a terminal having a social networking application compatible with each system platform installed, where the social networking application provides a unified electronic information interface compatible with each system platform. For the convenience of description, in this embodiment, an example in which electronic information in third-party system platforms: a system platform 1 and a system platform 2 is collected is used to describe in detail the method provided by this embodiment. Referring to FIG. 2, a procedure of the method provided by this embodiment is specifically as follows:

201: Acquire at least one electronic information identifier of electronic information in each system platform.

The system platform is an operating system platform, and may include, but is not limited to, an iOS system platform, or an Android system platform, or another system platform, and a specific type and a specific quantity of third-party system platforms are not limited in this embodiment.

A method for acquiring at least one electronic information identifier of electronic information in each system platform varies with a different representation form of an electronic information identifier, and a specific method for acquiring at least one electronic information identifier of electronic information in each system platform is not limited in this embodiment. A representation form of an electronic information identifier includes, but is not limited, to a two-dimensional code, a link in a web page, and an application (APP).

For example, if a representation form of an electronic information identifier 1 of electronic information 1 is a two-dimensional code, the electronic information identifier 1 is acquired by scanning the two-dimensional code. If a representation form of an electronic information identifier 2 of electronic information 2 is a link 1 in a web page A, the electronic information identifier 2 is acquired by opening the web page A and selecting the link 1.

If a representation form of an electronic information identifier 3 of electronic information 3 is a button 1 in an APP1, where the APP1 is an APP provided by a provider of the electronic information 3 for the system platform 1, the electronic information identifier 3 is acquired by opening the APP1 and clicking the “button 1”.

If a representation form of an electronic information identifier 4 of electronic information 4 is a select box 1 in an APP2, where the APP2 is an APP provided by a provider of the electronic information identifier 4 for the system platform 2, the electronic information identifier 4 is acquired by opening the APP2 and selecting the “select box 1”.

Certainly, a representation form of an electronic information identifier may also be another form, and a specific representation form of an electronic information identifier is not limited in this embodiment. In addition, each system platform may provide electronic information identifiers of different representation forms, and a representation form of an electronic information identifier provided by each system platform is not limited in this embodiment.

202: Acquire, by using the unified electronic information interface compatible with each system platform in the social networking application, electronic information corresponding to each electronic information identifier.

When the electronic information is collected by using the method provided by this embodiment of the present invention, the social networking application having the unified electronic information interface compatible with each system platform is used, and the unified electronic information interface is set in the social networking application that can be compatible with each system platform. The social networking application may be an existing social networking application that can be compatible with each system platform, and may also be a newly developed social networking application that can be compatible with each system platform, and neither a social networking application that can be compatible with each system platform nor a manner in which a unified electronic information interface that can be compatible with each system platform is set in the social networking application that can be compatible with each system platform is limited in this embodiment. Regardless of which unified electronic information interface compatible with each system platform, according to the method provided by this embodiment, the electronic information corresponding to each electronic information identifier can be acquired by using the unified electronic information interface.

Using the electronic information identifier 3 and the electronic information identifier 4 as an example, because the electronic information identifier 3 is specific to the system platform 1, the electronic information identifier 4 is specific to the system platform 2, and the unified electronic information interface is compatible with the system platform 1 and the system platform 2, the electronic information 3 corresponding to electronic information identifier 3 can be acquired by using the unified electronic information interface; and at the same time, the electronic information 4 corresponding to the electronic information identifier 4 can also be acquired by using the unified electronic information interface.

203: Save the acquired electronic information to perform unified collection; and process the electronic information according to a received instruction.

In this embodiment and another embodiment of this application, the collected electronic information may be electronic information used for payment, the electronic information corresponds to, but not limited to, coupon information, payment information, and the like, and a specific information type corresponding to the electronic information is not limited in this embodiment. For example, the electronic information may be electronic coupon information launched on a network by a merchant, and the electronic coupon information records commodity preference information of the merchant.

As an optional embodiment, for electronic information used for payment, the electronic information may further have timeliness, that is, the electronic information can be used for payment only in a period of validity, and if the period of validity is exceeded, a payment function of the electronic information is invalid. For example, an example in which the electronic information is electronic coupon information is used, and if a period of validity thereof expires on Oct. 31, 2014, before Oct. 31, 2014, the electronic information may be used for payment when a commodity corresponding to the electronic coupon information is purchased. After Oct. 31, 2014, the electronic coupon information is invalid and therefore cannot be used for purchasing the corresponding commodity.

In addition, in consideration of security when electronic information is used for payment, in addition to information such as an amount used for payment and descriptions of a function and use, the electronic information may further include, but is not limited to, security verification information and the like, and specific content of the electronic information is not limited in this embodiment.

Regardless of which electronic information, there may be multiple specific implementation manners of performing unified collection on the acquired electronic information, and a specific manner in which unified collection is performed on the acquired electronic information is not limited in this embodiment. For example, all acquired electronic information in all the third-party system platforms is sorted in descending order of remaining duration of periods of validity of the electronic information, and all the electronic information is stored according to a sorting result.

Using an example in which acquired electronic information is electronic information 5, electronic information 6, and electronic information 7; the electronic information 5 and the electronic information 6 are specific to the system platform 1; the electronic information 7 is specific to the system platform 2; a period of validity of the electronic information 5 is Apr. 24, 2014 to Apr. 27, 2014; a period of validity of the electronic information 6 is Apr. 22, 2014 to Apr. 25, 2014; a period of validity of the electronic information 7 is Apr. 26, 2014 to Apr. 29, 2014; and a date on which unified collection is performed on the acquired electronic information by using the method provided by this embodiment is Apr. 24, 2014, according to the date on which unified collection is performed on the acquired electronic information by using the method provided by this embodiment, it is determined that remaining duration of the period of validity of the electronic information 5 is 4 days, remaining duration of the period of validity of the electronic information 6 is 2 days, and remaining duration of the period of validity of the electronic information 7 is 4 days; therefore, the electronic information 5, the electronic information 6, and the electronic information 7 are sorted in descending order of the remaining duration of the periods of validity of the electronic information, and an obtained sorting result is: the electronic information 7, the electronic information 5, and the electronic information 6. In addition, because the remaining duration of periods of validity of both the electronic information 5 and the electronic information 7 is 4 days, a sorting result of the electronic information 6 and the electronic information 7 may be sorting according to names, that is, a final sorting result is: the electronic information 5, the electronic information 7, and the electronic information 6.

A period of validity of electronic information may also be another time period, and a time at which unified collection is performed on the acquired electronic information by using the method provided by this embodiment may also be another time, a method for sorting electronic information with same remaining duration of periods of validity may also be another method, and a specific time period of a period of validity of electronic information, a specific time at which unified collection is performed on the acquired electronic information, and a specific method for sorting electronic information with same remaining duration of periods of validity are not limited in this embodiment.

In addition to the foregoing method for performing unified collection on the acquired electronic information according to the remaining duration of periods of validity of all the electronic information, in specific implementation, unified collection may also be performed on the acquired electronic information according to the following method: all the acquired electronic information in all the third-party system platforms is classified according to the third-party system platforms; each type of system platform is sorted according to a name of the system platform; all pieces of electronic information in each type are sorted in descending order of remaining duration of periods of validity of the electronic information, to obtain a final sorting result; and all the electronic information is stored according to the final sorting result.

Still using the example in which the acquired electronic information is the electronic information 5, the electronic information 6, and the electronic information 7; the electronic information 5 and the electronic information 6 are specific to the system platform 1; the electronic information 7 is specific to the system platform 2; the period of validity of the electronic information 5 is Apr. 24, 2014 to Apr. 27, 2014; the period of validity of the electronic information 6 is Apr. 22, 2014 to Apr. 25, 2014; the period of validity of the electronic information 7 is Apr. 26, 2014 to Apr. 29, 2014; and the date on which unified collection is performed on the acquired electronic information by using the method provided by this embodiment is Apr. 24, 2014, according to the date on which unified collection is performed on the acquired electronic information by using the method provided by this embodiment, it is determined that the remaining duration of the period of validity of the electronic information 5 is 4 days, the remaining duration of the period of validity of the electronic information 6 is 2 days, and the remaining duration of the period of validity of the electronic information 7 is 4 days. If an alphabetical order corresponding to a name of the system platform 2 is higher than an alphabetical order corresponding to a name of the system platform 1, electronic information in the system platform 2 is sorted before electronic information in the system platform 1. Then, when electronic information in each system platform is sorted, the electronic information 5 and the electronic information 6 in the system platform 1 are sorted in descending order of the remaining duration of the periods of validity of the electronic information, and an obtained sorting result is: the electronic information 5, and the electronic information 6. Because only the electronic information 7 exists in the system platform 2, a final sorting result is: the electronic information 7, the electronic information 5, and the electronic information 6.

In addition, if the electronic information collected according to the foregoing method has different formats, storage resources of the electronic information are increased. In order to make the electronic information collected according to the foregoing method have a same format, before unified collection is performed on the acquired electronic information according to the foregoing method, unified processing may be further performed first on the acquired electronic information. A specific method for performing unified processing on the acquired electronic information is not limited in this embodiment, which includes, but is not limited to, unifying lengths and formats of the electronic information and the like.

In addition, after the electronic information is collected in the foregoing manner, as an optional embodiment, in order to make a user more clearly understand a specific situation of each piece of electronic information to enable the user to determine an actual use policy such as whether to and when to use each piece of electronic information according to the specific situation of each piece of electronic information, after step 203 of performing unified collection on the acquired electronic information is performed, a step of presenting the collected electronic information is further included, and for details, refer to a subsequent step.

204: Acquire an electronic information view instruction; and present the collected electronic information according to the electronic information view instruction.

A manner in which the electronic information view instruction is acquired is not limited in this embodiment, which specifically includes, but is not limited to, providing a view option on a collection interface of the electronic information, and after it is detected that the view option is selected, the electronic information view instruction is acquired. In addition, a manner in which the collected electronic information is presented according to the electronic information view instruction is not specifically limited in this embodiment either, which includes, but is not limited to, presenting all the collected electronic information in a form of a list of electronic information, or separately presenting the electronic information in each system platform in a form of multiple lists of electronic information, and each list of electronic information presenting electronic information in one system platform.

In addition, in an actual application process, after acquiring electronic information, a user uses the electronic information; therefore, after step 203 of performing unified collection on the acquired electronic information is performed, the electronic information view instruction is acquired, and the collected electronic information is presented according to the electronic information view instruction, as an optional embodiment, selected electronic information in the collected electronic information may be further determined; an electronic information payment instruction is acquired; payment information corresponding to the selected electronic information is acquired according to the electronic information payment instruction; and a payment related operation is performed according to the payment information.

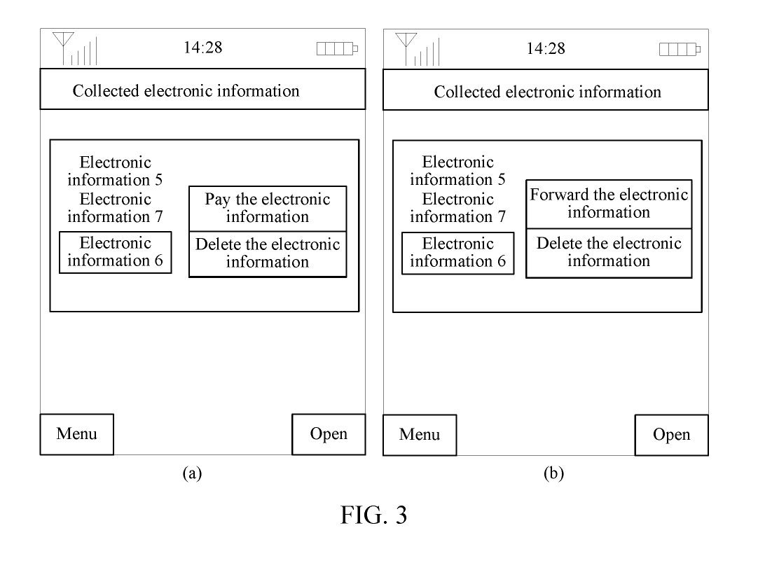

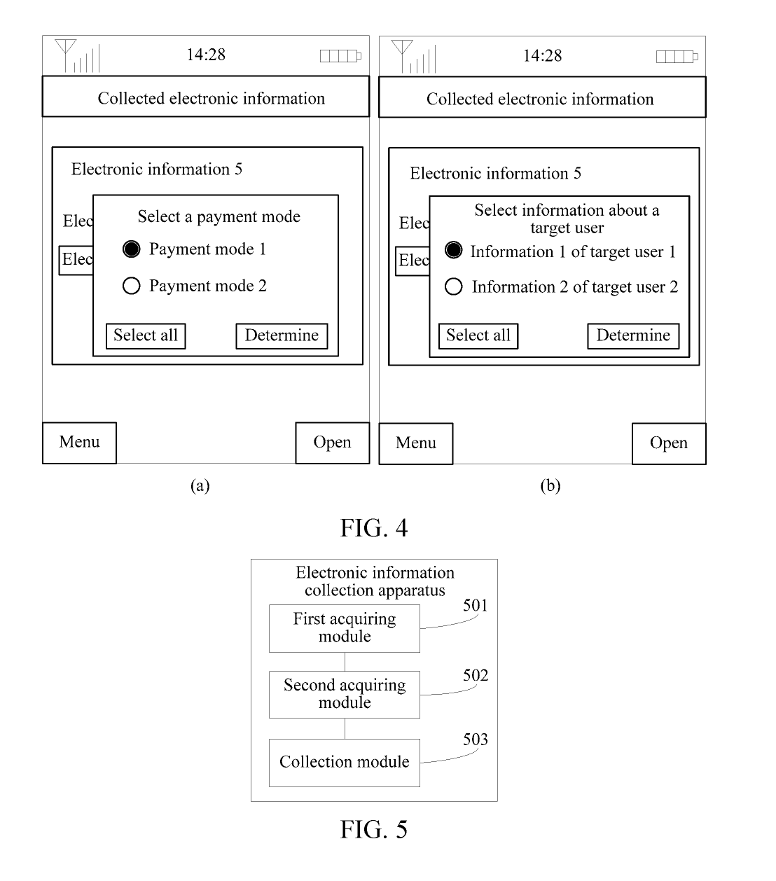

Using an electronic information presentation interface shown in FIG. 3(a) as an example, after a user selects the electronic information 6, if the user selects an option: “pay the electronic information” in a context menu, an interface shown in FIG. 4(a) pops up, and payment mode options that the user can use are listed, so as to enable the user to select a payment mode of the electronic information 6 from the listed payment modes. Payment information corresponding to the selected payment mode is acquired, and a payment related operation is performed according to the payment information. A manner in which the payment related operation is performed according to the payment information includes, but is not limited to, sending the payment information to a corresponding background server, and the background server verifying the payment information, and after the verification succeeds, completing a payment operation, and the like. In addition, for the performed payment related operation herein, reference may be made to a process of implementing payment in each application involved with a payment operation, which is not specifically limited in this embodiment.

In addition, in an actual application process, after acquiring electronic information, a user may always have a demand of forwarding the electronic information to another user. In order to meet the demand of the user of forwarding the electronic information to another user, after step 203 of performing unified collection on the acquired electronic information is performed, the electronic information view instruction is acquired, and the collected electronic information is presented according to the electronic information view instruction, as an optional embodiment, selected electronic information in the collected electronic information may be further determined; an electronic information forwarding instruction is acquired; information about a target user that receives the selected electronic information is determined according to a social relationship in the social networking application; and the selected electronic information is sent, according to the information about the target user, to a terminal corresponding to the target user.

Using an electronic information presentation interface shown in FIG. 3(b) as an example, after a user selects the electronic information 6, if the user selects an option: “forward the electronic information” in a context menu, an interface shown in FIG. 4(b) pops up, and social relationships of the user are listed, so as to enable the user to determine, according to the social relationships, information about a target user that receives the electronic information 6. If the user determines, according to the social relationships, that the information about the target user that receives the electronic information 6 is information 1 about a target user 1, the user sends, according to the information about the target user, the selected electronic information to a terminal corresponding to the target user 1.

It should be noted that, for the step of forwarding the selected electronic information to a terminal corresponding to the target user, in specific implementation, the selected electronic information may be shared with the target user, that is, a current user that performs forwarding and the target user both have the selected electronic information, and may also both use the selected electronic information. If the current user first uses the selected electronic information, when the target user uses the electronic information, because the electronic information has been used, the electronic information is invalid; and if the target user first uses the selected electronic information, when the current user uses the electronic information, because the electronic information has been used, the electronic information is invalid.

In addition, for the step of forwarding the selected electronic information to a terminal corresponding to the target user, in specific implementation, the selected electronic information may be further given to the target user, that is, the current user that performs forwards does not have the selected electronic information any longer, and the target user has the selected electronic information; therefore, only the target user can use the selected electronic information. For a case in which the selected electronic information is given to the target user, after the step of forwarding, according to the information about the target user, the selected electronic information to a terminal corresponding to the target user is performed, the selected electronic information is further deleted from the collected electronic information.

Alternatively, after the step of forwarding, according to the information about the target user, the selected electronic information to a terminal corresponding to the target user is performed, it is determined whether the selected electronic information is forwarded successfully; if the selected electronic information fails to be forwarded, information indicating that the selected electronic information fails to be forwarded is prompted, so that the user decides, according to the prompted information indicating that the selected electronic information fails to be forwarded, whether to forward the selected electronic information again; and if the selected electronic information is forwarded successfully, the selected electronic information is deleted from the collected electronic information.

A specific operation after the selected electronic information is forwarded, according to the information about the target user, the terminal corresponding to the target user is not limited in this embodiment.

A determining criterion of determining whether the selected electronic information is forwarded successfully is not limited in this embodiment either, and if the selected electronic information is not sent successfully, it is determined that the selected electronic information is not forwarded successfully. Alternatively, if the selected electronic information is sent successfully, but the target user does not receive the selected electronic information, it is also determined that the selected electronic information is not forwarded successfully. A specific method for determining that the target user does not receive the selected electronic information is not limited in this embodiment. For example, if an abandon message indicating that the target user abandons receiving selected electronic information and returned by the target user is received within a period of time, it is determined that the target user does not receive the selected electronic information.

In addition, only an example in which the electronic information collection method provided by this embodiment is applied to a terminal, and an apparatus serving as the terminal collects the electronic information is used above for explanation and description. In addition, the method provided by this embodiment may also be applied to software, and a module serving as the software collects the electronic information. A specific application of the electronic information collection method provided by this embodiment is not limited in this embodiment, and specific software to which the method provided by this embodiment is applied is not limited in this embodiment either.

According to the method provided by this embodiment, electronic information in each system platform is collected by using a unified electronic information interface compatible with each system platform, so that not only are the complexity and the cost of collecting the electronic information reduced, but also the efficiency of collecting the electronic information is improved. In addition, the collected electronic information is forwarded to another terminal of a target user based on a social relationship, so that not only is a manner in which the collected electronic information is management enriched, but also social experience of a user can be improved.

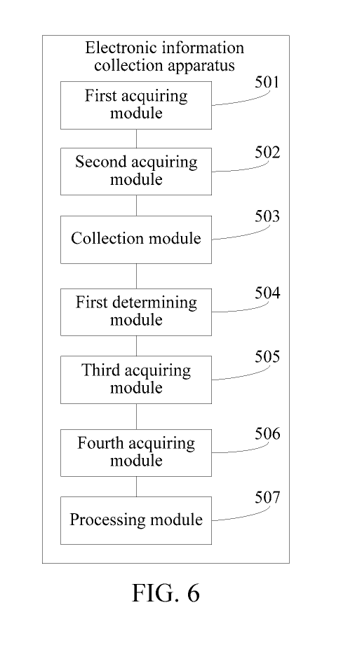

Another embodiment of the present invention provides an electronic information collection apparatus. The apparatus is applied to a terminal having a social networking application compatible with each system platform installed, where the social networking application provides a unified electronic information interface compatible with each system platform. The apparatus is configured to perform the electronic information collection method provided by the foregoing embodiment. Referring to FIG. 5, the apparatus includes:

a first acquiring module 501, configured to acquire at least one electronic information identifier of electronic information in each system platform;

a second acquiring module 502, configured to acquire, by using the unified electronic information interface compatible with each system platform in the social networking application, electronic information corresponding to each electronic information identifier acquired by the first acquiring module 501; and
a collection module 503, configured to perform unified collection on the acquired electronic information by the second acquiring module 502, and process the electronic information according to a received instruction.

Referring to FIG. 6, the apparatus further includes:

a first determining module 504, configured to determine selected electronic information in the collected electronic information;

a third acquiring module 505, configured to acquire an electronic information payment instruction;

a fourth acquiring module 506, configured to acquire, according to the electronic information payment instruction acquired by the third acquiring module 505, payment information corresponding to the selected electronic information determined by the first determining module 504; and

a processing module 507, configured to perform a payment related operation according to the payment information acquired by the fourth acquiring module 506.

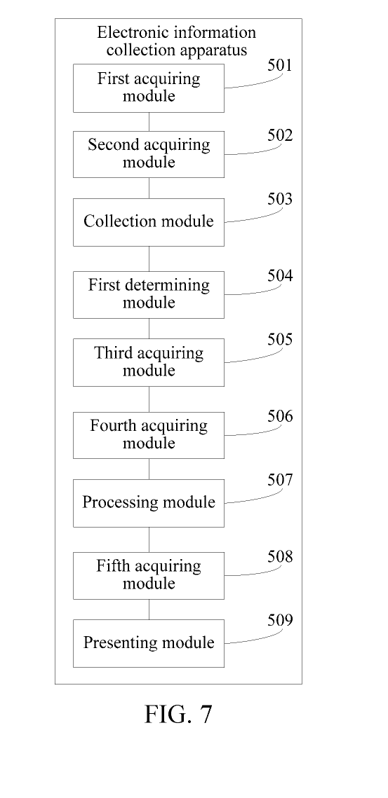

Referring to FIG. 7, the apparatus further includes:

a fifth acquiring module 508, configured to acquire an electronic information view instruction; and

a presenting module 509, configured to present the collected electronic information according to the electronic information view instruction acquired by the fifth acquiring module 508.

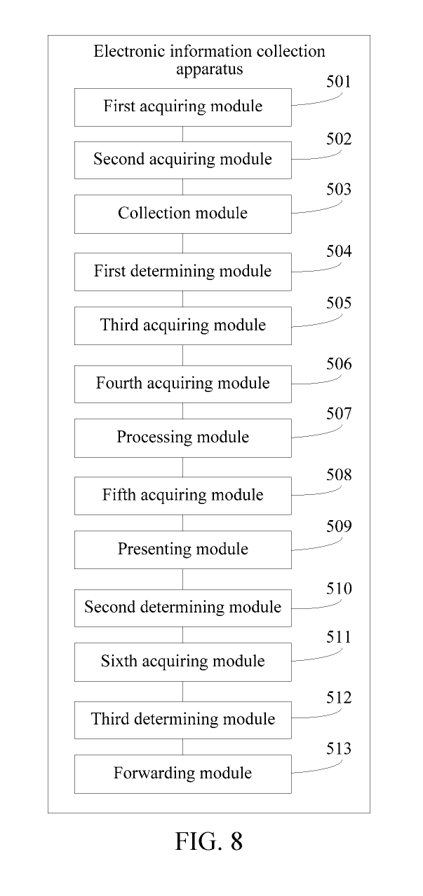

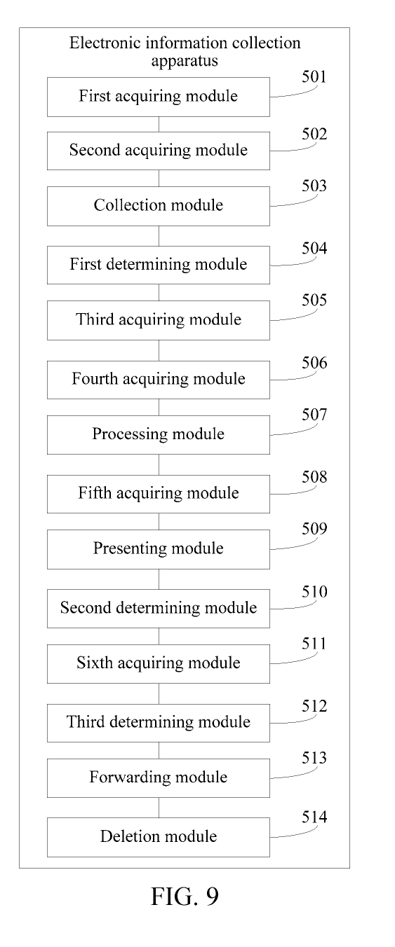

Referring to FIG. 8, the apparatus further includes:

a second determining module 510, configured to determine selected electronic information in the collected electronic information;

a sixth acquiring module 511, configured to acquire an electronic information forwarding instruction;

a third determining module 512, configured to determine, according to a social relationship in the social networking application, information about a target user that receives the selected electronic information determined by the second determining module 510; and

a forwarding module 513, configured to forward, according to the information about the target user that is determined by the third determining module 512, the selected electronic information determined by the second determining module 510 to a terminal corresponding to the target user.

Referring to FIG. 9, the apparatus further includes:

a deletion module 514, configured to delete the selected electronic information from the collected electronic information.

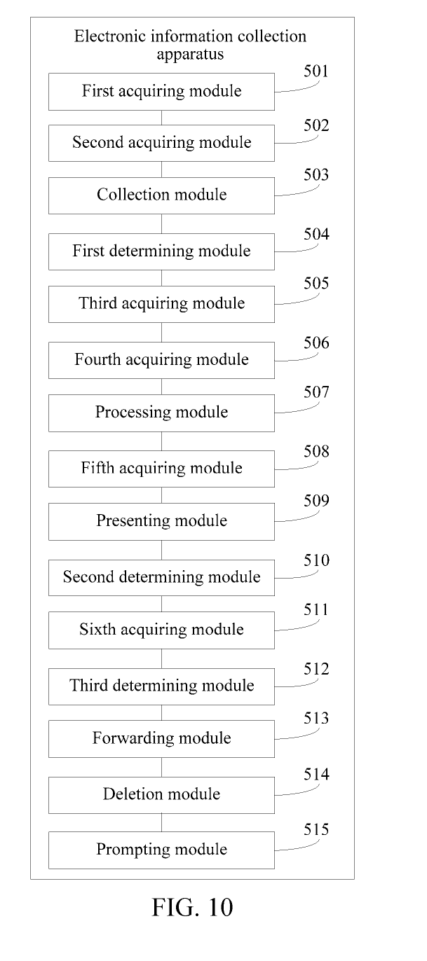

Referring to FIG. 10, the apparatus further includes:

a prompting module 515, configured to prompt, after the selected electronic information fails to be forwarded, information indicating that the selected electronic information fails to be forwarded.

The apparatus provided by this embodiment collects electronic information in each system platform by using a unified electronic information interface compatible with each system platform and provided by a social networking application, so that not only are the complexity and the cost of collecting the electronic information reduced, but also the efficiency of collecting the electronic information is improved. In addition, the collected electronic information is forwarded to another terminal of a target user based on a social relationship, so that not only is a manner in which the collected electronic information is management enriched, but also social experience of a user can be improved.

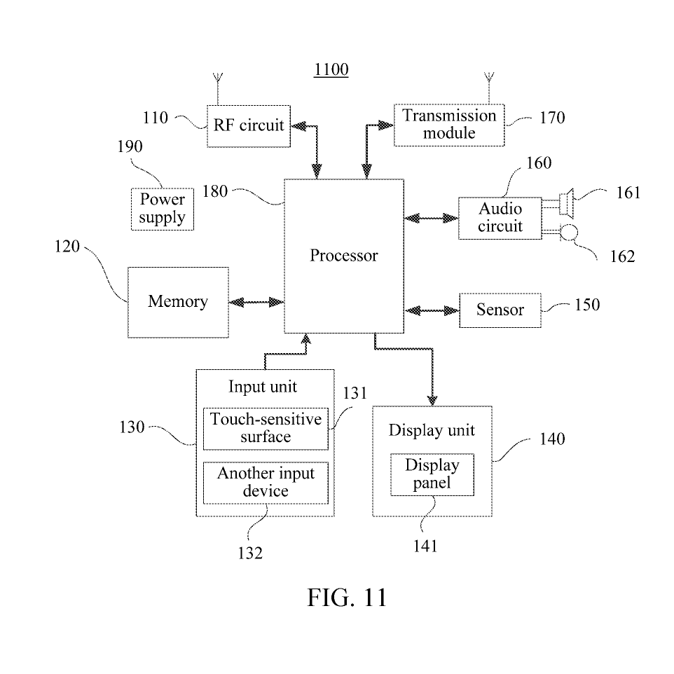

Referring to FIG. 11, this embodiment provides a terminal. The terminal has a social networking application compatible with each system platform installed, where the social networking application provides a unified electronic information interface compatible with each system platform. FIG. 11 shows a schematic structural diagram of a terminal having a touch-sensitive surface involved in an embodiment of the present invention. The terminal may be configured to implement the electronic information collection method provided by the foregoing embodiment. Specifically:

The terminal 1100 may include components such as a radio frequency (RF) circuit 110, a memory 120 including one or more computer readable storage mediums, an input unit 130, a display unit 140, a sensor 150, an audio circuit 160, a transmission module 170, a processor 180 including one or more processing cores, and a power supply 190. A person skilled in the art may understand that the structure of the terminal shown in FIG. 11 does not constitute a limitation to the terminal, and the terminal may include more components or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), general packet radio service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module, for example, software programs and modules corresponding to the electronic information collection apparatus in the embodiments. The processor 180 runs the software program and module stored in the memory 120, to implement various functional applications and data processing, for example, to implement electronic information collection and the like. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1100, and the like. In addition, the memory 120 may include a high speed random access memory, and may also include a non-volatile memory, such as at least one magnetic disk storage device, a flash memory, or another volatile solid state storage device. Correspondingly, the memory 120 may further include a memory controller for the processor 180 and the input unit 130 to access the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on the touch-sensitive surface 131 or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be a resistive, capacitive, infrared, or surface sound wave type touch-sensitive surface 131. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 1100. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although, in FIG. 11, the touch-sensitive surface 131 and the display panel 141 are used as two separate components to implement input and output functions, in some embodiments, the touch-sensitive surface 131 and the display panel 141 may be integrated to implement the input function and output functions.

The terminal 1100 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1100 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors such as a gyroscope, a barometer, a hygrometer, a thermometer, and an infrared sensor, which may be configured in the terminal 1100, are not further described herein.

The audio circuit 160, a loudspeaker 161, and a microphone 162 may provide audio interfaces between the user and the terminal 1100. The audio circuit 160 may convert received audio data into an electric signal and transmit the electric signal to the loudspeaker 161. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1100.

The terminal 1100 may help, by using the transmission module 170, a user to receive and send an e-mail, browse a web page, and access streaming media, and so on, which provides wireless or wired broadband Internet access for the user. Although FIG. 11 shows the transmission module 170, it may be understood that, the transmission module 170 does not belong to a necessary constitution of the terminal 1100, and can be ignored according to demands without changing the scope of the essence of the present disclosure.

The processor 180 is the control center of the terminal 1100, and is connected to various parts of the terminal 1100 by using various interfaces and lines. By running or executing the software program and/or module stored in the memory 120, and invoking data stored in the memory 120, the processor 180 performs various functions and data processing of the terminal 1100, thereby performing overall monitoring on the terminal. Optionally, the processor 180 may include the one or more processing cores. Preferably, the processor 180 may integrate an application processor and a modem. The application processor mainly processes an operating system, a user interface, an application program, and the like. The modem mainly processes wireless communication. It may be understood that, the foregoing modem may be not integrated into the processor 180.

The terminal 1100 further includes the power supply 190 (such as a battery) for supplying power to the components. Preferably, the power supply may be logically connected to the processor 180 by using a power management system, thereby implementing functions, such as charging, discharging, and power consumption management, by using the power management system. The power supply 190 may further include one or more of a direct current or alternating current power supply, a re-charging system, a power failure detection circuit, a power supply converter or inverter, a power supply state indicator, and any other components.

Although not shown in the figure, the terminal 1100 may further include a camera, a Bluetooth module, and the like, which are not described in detail herein again. Specifically, in this embodiment, the display unit of the terminal is a touch screen display, and the terminal may further include a memory and one or more programs. The one or more programs are stored in the memory and configured to be executed by one or more processors. The one or more programs implement the electronic information collection method in the present disclosure.

It should be noted that the above functional modules are only described for exemplary purposes when the electronic information collection apparatus provided by the foregoing embodiment collects electronic information. In actual applications, the functions may be allocated to different functional modules according to specific needs, which means that the internal structure of the electronic information collection apparatus is divided to different functional modules to complete all or some of the above described functions. In addition, the electronic information collection apparatus provided by the foregoing embodiment belongs to the same concept as the embodiment of the electronic information collection method, and for the specific implementation process, reference may be made to the method embodiment, and details are not provided herein again.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. An electronic information collection method performed at a mobile terminal, the mobile terminal comprising a memory, one or more processors, and program instructions stored in the memory and executed by the one or more processors, and the method comprising:
providing a social networking application installed in the mobile terminal, the social networking application having a unified electronic information interface compatible with different third-party system platforms;
collecting at least one electronic information identifier from each of the third-party system platforms;
acquiring, by using the unified electronic information interface compatible with different third-party system platforms in the social networking application, electronic information corresponding to each of the at least one electronic information identifier, from the third-party system platforms;
generating an unified collection by saving the acquired electronic information in a user account associated with the social networking application;
in response to a received user instruction of forwarding the electronic information corresponding to one electronic information identifier:
sending the electronic information to another user account with the social networking application installed in another mobile terminal; and
deleting the electronic information from the unified collection.

2. The method according to claim 1, further comprising:
receiving an electronic information payment instruction associated with user-selected electronic information in the unified collection;
acquiring, according to the electronic information payment instruction, payment information corresponding to the user-selected electronic information; and
performing a payment operation according to the payment information.

3. The method according to claim 1, further comprising:
when the user-selected electronic information fails to be sent, displaying one piece of alert information on an interface provided by the mobile terminal, indicating that the user-selected electronic information fails to be sent.

4. The method according to claim 1, comprising:
acquiring an electronic information view instruction; and
presenting the collected electronic information according to the electronic information view instruction.

5. A mobile terminal for electronic information collection comprising:
memory,
one or more processors, and
a plurality of program modules stored in the memory and executed by the one or more processors, and the plurality of program modules further comprising instructions for:
providing a social networking application installed in the mobile terminal, the social networking application having a unified electronic information interface compatible with different third-party system platforms;
collecting at least one electronic information identifier from each of the third-party system platforms;
acquiring, by using the unified electronic information interface compatible with different third-party system platforms in the social networking application, electronic information corresponding to each of the at least one electronic information identifier, from the third-party system platforms;
generating an unified collection by saving the acquired electronic information in a user account associated with the social networking application;
in response to a received user instruction of forwarding the electronic information corresponding to one electronic information identifier:
sending the electronic information to another user account with the social networking application installed in another mobile terminal; and
deleting the electronic information from the unified collection.

6. The mobile terminal according to claim 5, wherein the plurality of program modules further comprise instructions for:
receiving an electronic information payment instruction associated with user-selected electronic information in the unified collection;
acquiring, according to the electronic information payment instruction, payment information corresponding to the user-selected electronic information; and
performing a payment operation according to the payment information.

7. The mobile terminal according to claim 5, wherein the plurality of program modules further comprise instructions for:
when the user-selected electronic information fails to be sent, displaying one piece of alert information on an interface provided by the mobile terminal, indicating that the user-selected electronic information fails to be sent.

8. The mobile terminal according to claim 5, wherein the plurality of program modules further comprise instructions for:
acquiring an electronic information view instruction; and
presenting the collected electronic information according to the electronic information view instruction.

9. A non-transitory computer readable storage medium in connection with a mobile terminal, the mobile terminal comprising a memory, one or more processors, and program instructions stored in the memory and executed by the one or more processors, the computer readable storage medium including a plurality of program instructions for:
providing a social networking application installed in the mobile terminal, the social networking application having a unified electronic information interface compatible with different third-party system platforms;
collecting at least one electronic information identifier from each of the third-party system platforms;
acquiring, by using the unified electronic information interface compatible with different third-party system platforms in the social networking application, electronic information corresponding to each of the at least one electronic information identifier, from the third-party system platforms;
generating an unified collection by saving the acquired electronic information in a user account associated with the social networking application;
in response to a received user instruction of forwarding the electronic information corresponding to one electronic information identifier:
sending the electronic information to another user account with the social networking application installed in another mobile terminal; and
deleting the electronic information from the unified collection.

10. The non-transitory computer readable storage medium according to claim 9, wherein the plurality of program instructions further comprise:
receiving an electronic information payment instruction associated with user-selected electronic information in the unified collection;
acquiring, according to the electronic information payment instruction, payment information corresponding to the user-selected electronic information; and
performing a payment operation according to the payment information.

11. The non-transitory computer readable storage medium according to claim 9, wherein the plurality of program instructions further comprise:
when the user-selected electronic information fails to be sent, displaying one piece of alert information on an interface provided by the mobile terminal, indicating that the user-selected electronic information fails to be sent.

12. The non-transitory computer readable storage medium according to claim 9, wherein the plurality of program instructions further comprise:
acquiring an electronic information view instruction; and
presenting the collected electronic information according to the electronic information view instruction.
